(19) United States
(12) Patent Application Publication
(10) Pub. No.: US 2013/0205611 A1
(43) Pub. Date: Aug. 15, 2013

(54) GAS SUPPLY APPARATUS AND HEAT TREATMENT APPARATUS

(71) Applicant: TOKYO ELECTRON LIMITED, (US)

(72) Inventors: Yu WAMURA, Oshu-shi (JP); Yusuke TACHINO, Nirasaki City (JP); Hiromi SHIMA, Nirasaki City (JP)

(73) Assignee: TOKYO ELECTRON LIMITED, Tokyo (JP)

(21) Appl. No.: 13/766,285

(22) Filed: Feb. 13, 2013

(30) Foreign Application Priority Data
Feb. 13, 2012 (JP) 2012-28494

(51) Int. Cl. F26B 19/00

(52) U.S. Cl. CPC F26B 19/00
USPC 34/60; 137/154

(57) ABSTRACT

Provided is a gas supply apparatus having a source gas supply system configured to supply a source gas to a processing container using a carrier gas, wherein the source gas is generated from a liquid raw material consisting of an organic metal material. The gas supply apparatus includes a raw material storage tank configured to store the liquid raw material therein; a gas supply portion installed to the raw material storage tank and connected to a carrier gas passage, wherein the carrier gas passage allows the carrier gas to flow; a gas outflow portion installed to the raw material storage tank and connected to a source gas passage, wherein the source gas passage allows the source gas to flow; and a baffle plate configured to prevent the carrier gas injected from the gas supply portion from being brought into direct contact with a liquid surface of the raw material.

### CROSS-REFERENCE TO RELATED APPLICATION

This application claims the benefit of and priority from Japanese Patent Application No. 2012-028494, filed on Feb. 13, 2012, in the Japan Patent Office, the disclosure of which is incorporated herein in its entirety by reference.

### TECHNICAL FIELD

The present disclosure relates to a heat treatment apparatus for performing heat treatment on an object to be treated such as a semiconductor wafer, and a gas supply apparatus used thereto.

### BACKGROUND

Generally, in order to manufacture a semiconductor integrated circuit, a variety of treatments, such as film formation treatments, etching treatments, oxidation treatments, diffusion treatments, modification treatments, removal treatments of native oxide film, and the like are performed on a semiconductor wafer such as a silicon substrate. Such treatments are performed in a single type treatment apparatus for treating wafers one by one or in a batch type treatment apparatus for treating a plurality of wafers at a time. For example, when these treatments are performed in a conventional vertical type, so-called batch type treatment apparatus, first, semiconductor wafers from a cassette capable of accommodating a plurality of wafers, e.g., about 25 sheets of wafers, are transferred and loaded to a vertical type wafer boat and then supported therein in a multistage manner.

The wafer boat can load, for example, about 30 to 150 sheets of wafers although the number of wafers may vary according to wafer size. The wafer boat enters (is loaded into) an evacuable processing container from below, and then, the inside of the processing container is air-tightly maintained. Then, while a variety of process conditions such as flow rate of processing gas, process pressure, and process temperature are controlled, a predetermined heat treatment is performed.

For the film formation treatment as an example, recently, in terms of improving properties of a semiconductor integrated circuit, a variety of metal materials tend to be used. For example, metal materials, such as zirconium (Zr) and ruthenium (Ru), which have not been used in a conventional method of manufacturing a semiconductor integrated circuit, are used. In general, such metals are combined with an organic material into a liquid organic metal material, which is used as a raw material. The raw material is placed in a raw material storage tank that is an airtight container and heated to generate a source gas. The source gas, which is saturated in the raw material storage tank, is delivered by a carrier gas such as a rare gas and used in the film formation treatment or the like.

However, recently, the diameter of a semiconductor wafer W has gradually increased. For example, the diameter of a wafer is due to be further increased from 300 mm up to 450 mm in the future. Also, a large amount of source gas is required to be flown in view of that need a capacitor insulating film of DRAMs having a high aspect ratio structure needs to be formed to achieve good step coverage in association with device miniaturization or increase of the throughput of a film formation treatment. For example, if a low amount of the source gas is supplied, consumption of the source gas is increased in a periphery of a wafer rotating during the film formation, so that the source gas tends to be insufficient in the central portion of the wafer, which causes degradation of in-plane uniformity in film thickness. Further, in order to increase the flow rate of the source gas, a large amount of carrier gas is needed to thereby increase the flow rate of the source gas, which is saturated in a raw material storage tank.

However, if the flow rate of the carrier gas is increased in order to increase the flow rate of the source gas, the carrier gas introduced into the raw material storage tank strongly collides with a liquid surface of the liquid raw material. On this account, the liquid surface of the raw material fluctuates widely, and in severe cases, bubbles are incorporated into the liquid surface, which causes the generation of particles.

In particular, when a film is formed by a so-called ALD (Atomic Layer Deposition) process, in which the supply of the source gas and the stop thereof are intermittently repeated, the particles are necessarily generated whenever the supply of the source gas is started. Thus, there is a need to resolve undesired particles at an early stage of such treatments.

### SUMMARY

Various embodiments of the present disclosure are related to a gas supply apparatus and a heat treatment apparatus, which are capable of suppressing the generation of particles and supplying a large amount of source gas.

According to some aspects of the present disclosure, provided is a gas supply apparatus having a source gas supply system configured to supply a source gas to a processing container using a carrier gas, wherein the source gas is generated from a liquid raw material consisting of an organic metal material, and wherein the processing container performs heat treatment on an object to be treated, the gas supply apparatus comprising: a raw material storage tank configured to store the liquid raw material therein; a gas supply portion installed to the raw material storage tank and connected to a carrier gas passage, wherein the carrier gas passage allows the carrier gas to flow; a gas outflow portion installed to the raw material storage tank and connected to a source gas passage, wherein the source gas passage allows the source gas to flow; and a baffle plate configured to prevent the carrier gas injected from the gas supply portion from being brought into direct contact with a liquid surface of the raw material.

According to some other aspects of the present disclosure, provided is a heat treatment apparatus configured to perform heat treatment on an object to be treated, comprising: a processing container configured to accommodate the object to be treated therein; a holding unit configured to hold and support the object to be treated in the processing container; a heater configured to heat the object to be treated; an evacuation system configured to evacuate the atmosphere of processing container therein; and the aforementioned gas supply apparatus.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a longitudinal sectional view of a heat treatment apparatus, according to some embodiments.

FIG. 2 is a transverse sectional view showing the heat treatment apparatus of FIG. 1.

FIGS. 3A to 3B show enlarged views of a raw material storage tank of a source gas supply system, according to some embodiments.

FIG. 4 is a graphical representation showing evaluation results of a gas supply apparatus, according to some embodiments.

FIG. 5 is a diagram showing a relationship between the flow rate of a carrier gas, a distance between a baffle plate and a liquid surface of a raw material, and a state of the liquid surface, according to some embodiments.

FIGS. 6A to 6C show partially enlarged views of modifications of a gas supply portion of the source gas supply system of the gas supply apparatus, according to some embodiments.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

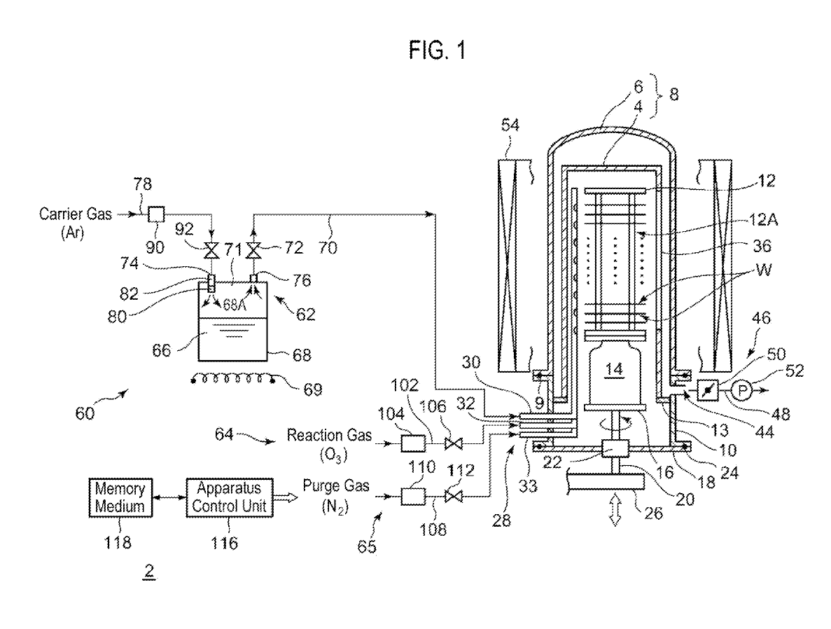

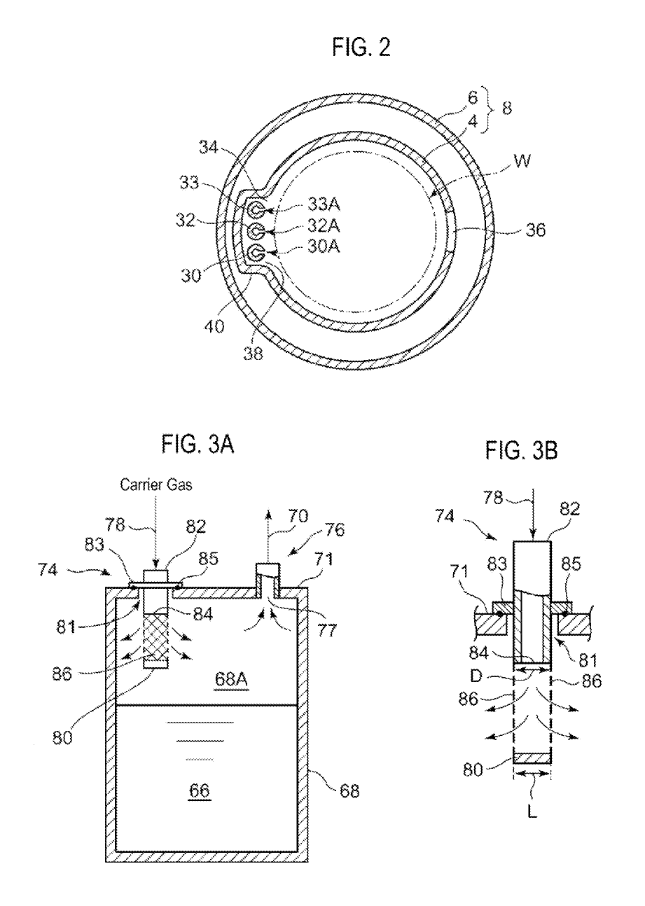

Hereinafter, one embodiment of a gas supply apparatus and heat treatment apparatus according to the present disclosure will be described in detail based on the accompanying drawings. FIG. 1 is a longitudinal sectional view showing a heat treatment apparatus, according to some embodiments, FIG. 2 is a transverse sectional view showing the heat treatment apparatus (from which a heater is omitted), and FIG. 3 shows enlarged views of a raw material storage tank of a source gas supply system, according to some embodiments, wherein FIG. 3A is an enlarged view of the entirety thereof, and FIG. 3B is an enlarged view of a gas supply portion.

As shown in the figures, a heat treatment apparatus 2 includes a processing container 8 of a double-container structure consisting of a cylindrical inner container 4 having a flat plate-shaped ceiling and a cylindrical outer container 6 concentrically arranged outside thereof and having a dome-shaped ceiling. Both the inner container 4 and the outer container 6 are made of a heat resistant material, for example, quartz. A lower end of the processing container 8 is connected to and supported by a cylindrical manifold 10, for example, made of stainless steel, through a sealing member 9 such as an O-ring.

A lower end of the inner container 4 is supported on a support ring 13 mounted to an inner wall of the manifold 10. Also, the apparatus may be configured to include a circular cylindrical processing container of quartz as a whole without installing the manifold 10 of stainless steel.

The manifold 10 is formed in the shape of a circular cylindrical body. A wafer boat 12 made of quartz, which is a holding unit for loading a plurality of semiconductor wafers W, which are objects to be treated, in a multistage manner, is configured to be liftably inserted into or separated from the manifold 10 through a bottom thereof In this embodiment, pillars 12A of the wafer boat 12 are allowed, for example, about 50 to 150 sheets of wafers W having a diameter of 300 mm to be supported thereon in a multistage manner at an approximately regular pitch.

The wafer boat 12 is mounted on a table 16 through a thermos container 14 of quartz, and the table 16 is supported on a rotating shaft 20, which penetrates a lid portion 18, for example made of stainless steel, for opening and closing a lower end opening of the manifold 10. In addition, the portion penetrated by the rotating shaft 20, for example, is fitted with a magnetic fluid seal 22 and air-tightly seals and rotatably supports the rotating shaft 20. In addition, a sealing member 24 such as an O-ring is interposed and installed between a periphery of the lid portion 18 and the lower end of the manifold 10 and maintains a sealing property in the processing container 8.

The rotating shaft 20 is mounted to a leading end of an arm 26 supported by a lift mechanism (not shown) such as a boat elevator and is configured to lift up or down the wafer boat 12, the lid portion 18, and the like together so that they can be inserted into or separated from the processing container 8. In addition, the table 16 may be fixedly installed to the lid portion 18, and then, the wafers W may be treated without rotating the wafer boat 12. The processing container 8 is fitted with a gas introduction portion 28.

Specifically, the gas introduction portion 28 has a plurality of gas dispersion nozzles, for example, three gas dispersion nozzles 30, 32 and 33 in this embodiment, each of which includes a quartz tube penetrating a sidewall of the manifold 10 inwards and bent and extending upwards. Each of the gas dispersion nozzles 30, 32 and 33 has a plurality (large number) of gas injection holes 30A, 32A or 33A formed along its lengthwise direction to be spaced apart from each other at a predetermined interval, wherein the gas injection holes 30A, 32A or 33A are allowed to almost uniformly inject gas in the horizontal direction.

A nozzle reception concave portion 34 (see FIG. 2) is formed in a portion of a sidewall of the inner container 4 of the processing container 8 along its heightwise direction, while a narrow and long exhaust opening 36 is formed in the opposite side of the processing container 8 facing the nozzle reception concave portion 34 by partially cutting the sidewall of the inner container 4 off, for example in the vertical direction, in order to evacuate the atmosphere of the inner container 4. Specifically, the nozzle reception concave portion 34 is formed in such a manner that a vertically narrow and elongated opening 38 is formed by cutting the sidewall of the processing container 8 off in the vertical direction within a predetermined width, and then, a vertically narrow and elongated partition wall 40, for example made of quartz, having a concave cross section shape to cover the opening 38 from the outside thereof is air-tightly welded and bonded to an outer wall of the inner container 4. In addition, as shown in FIG. 2, the respective gas dispersion nozzles 30, 32 and 33 are installed in the nozzle reception concave portion 34 side by side.

Further, a gas outlet 44 in communication with the exhaust opening 36 is formed in an upper portion of a sidewall of the support ring 13 of the manifold 10, and the atmosphere in the inner container 4 is discharged into a gap between the inner container 4 and the outer container 6 through the exhaust opening 36 and reaches the gas outlet 44. In addition, the gas outlet 44 is fitted with an evacuation system 46. The evacuation system 46 has an exhaust passage 48 connected to the gas outlet 44. The exhaust passage 48 is fitted with a pressure adjustment valve 50 or vacuum pump 52 to evacuate the processing container 8 while maintaining the inside of the processing container 8 at a predetermined pressure. In addition, a cylindrical heater 54 is installed to enclose an outer periphery of the processing container 8, thereby heating the processing container 8 and the wafers W therein.

Further, a gas supply apparatus 60 is installed to supply the processing container 8 with gas necessary for heat treatment. Here, the gas supply apparatus 60 includes a source gas supply system 62 having a feature for supplying a source gas, as well as a reaction gas supply system 64 for supplying a reaction gas reacting with the source gas and a purge gas supply system 65 for supplying a purge gas. Specifically, the source gas supply system 62 has a raw material storage tank 68 for storing a liquid raw material 66 including an organic metal material. The raw material storage tank 68 is also referred to as an ampoule or a reservoir.

As the raw material 66, ZrCp(NMe₂)₃[cyclopentadienyl.tris(dimethylamino)zirconium, which is a liquid organic compound of zirconium, may be used. Alternatively, Zr(MeCp)(NMe₂)₃[methylcyclopentadienyl.tris(dimethylamino)zirconium, Ti(MeCp)(NMe₂)₃[methylcyclopentadienyl.tris(dimethylamino)titanium, tetrakis(dimethylamino)hafnium, or the like may also be used. The raw material storage tank 68 is fitted with a raw material heater 69 for generating a source gas by heating the raw material 66 for vaporization in a temperature range allowing the raw material 66 not to be thermally decomposed, wherein the raw material 66 is heated, for example, to 70 to 100 degrees C. or so.

Further, the raw material storage tank 68 is fitted with a gas supply portion 74 for supplying a carrier gas for carrying a source gas, and a gas outflow portion 76 for allowing the source gas carried by the carrier gas to flow out. Here, both the gas supply portion 74 and the gas outflow portion 76 are installed in a ceiling of the raw material storage tank 68.

In addition, a source gas passage 70 is defined by connecting the gas outflow portion 76 of the raw material storage tank 68 with one of the three gas dispersion nozzles 30, 32 and 33, for example, the gas dispersion nozzle 30, of the gas introduction portion 28 installed to the processing container 8. An opening/closing valve 72 is installed in the middle of the source gas passage 70 to control the flow of the source gas.

In addition, a gas outflow port 77 upstream of the source gas passage 70 is positioned to face an upper space portion 68A in the raw material storage tank 68 and allows the source gas generated therein to flow out together with the carrier gas. Accordingly, a passage heater (not shown) such as a tape heater is installed to the source gas passage 70 to heat the source gas passage 70, for example, to 70 to 100 degrees C. or so, thereby preventing the source gas from being liquefied.

Further, the gas supply portion 74 of the raw material storage tank 68 is connected to a carrier gas passage 78 for introducing the carrier gas into the raw material storage tank 68. Also, the gas supply portion 74 is fitted with a baffle plate 80 having a feature for preventing the carrier gas injected from the gas supply portion 74 from being brought into direct contact with the liquid surface of the raw material 66.

Specifically, the gas supply portion 74 has a gas nozzle 82, which penetrates and is mounted to an insertion and penetration hole 81 provided in a ceiling 71 of the raw material storage tank 68. The gas nozzle 82 is provided with a flange portion 83 and is air-tightly detachably mounted by interposing a sealing member 85 such as an O-ring between the flange portion 83 and the ceiling 71. In addition, a gas supply opening 84 is defined in a lower end of the gas nozzle 82, which is a leading end thereof The gas supply opening 84 is positioned to face the upper space portion 68A of the raw material storage tank 68.

In addition, the baffle plate 80 is formed, for example, in the shape of a circular disk, and a mesh member 86 in the shape of a net having a ventilation property (see FIG. 3) is installed by connecting the gas supply opening 84 and the baffle plate 80 to enclose a space therebetween. The mesh member 86 is formed in the shape of an annular or a tube. That is, the mesh member 86 causes the baffle plate 80 to be installed to be supported in a gas injection direction, herein, immediately below the gas supply opening 84 in this embodiment.

Further, in this embodiment, the baffle plate 80 is installed perpendicular to the gas injection direction and is parallel with the liquid surface of the raw material 66. Thus, the carrier gas injected directly below the gas supply opening 84 therefrom is brought into direct contact with the baffle plate 80, without directly contacting the liquid surface of the raw material 66, and changes its flow direction, passes through the mesh member 86, and then is supplied to the upper space portion 68A in the raw material storage tank 68. The gas nozzle 82, the baffle plate 80 and the mesh member 86 all are made of a corrosion resistance material, such as stainless steel.

Here, the gas supply opening 84 has a diameter D in a range from 1 to 5 mm or so, for example 3.2 mm or so, the baffle plate 80 has a length L in a range from 1 to 25 mm or so, for example 3.2 mm or so, and a dimensional relationship therebetween is “D/2≦L≦2·D.” Here, if “D/2>L,” the diameter of the baffle plate 80 is too small, so that the effect of installing the baffle plate 80 is lost. Also, if “L>2·D,” since the effect of installing the baffle plate 80 is saturated, it is sufficient that the upper limit of the diameter of the baffle plate 80 is “2D.” In addition, if it is set to be “D/2≦L<D,” the diameter of the baffle plate 80 is smaller than that of the gas supply opening 84 (the gas nozzle 82). Thus, the baffle plate 80 together with the gas nozzle 82 can be attached to or detached from the mount hole of the ceiling of the raw material storage tank 68, so that it is possible to easily perform maintenance tasks.

Further, if it is set to be “L≧D,” the insertion and penetration hole 81 and the flange portion 83 are set to be large corresponding thereto, thereby making it possible to attach or detach the gas nozzle 82. In addition, the mesh member 86 has a mesh size in a range from 0.1 to 1.0 μm or so, for example 0.4 μm, and the mesh size is set to sufficiently weaken the flow force of the carrier gas. Also, the mesh member 86 has a vertical length of 10 to 50 mm or so.

Returning to FIG. 1, a flow rate controller 90 such as a mass flow controller for controlling the gas flow rate and an opening/closing valve 92 are installed in sequence in the middle of the carrier gas passage 78 from an upstream side of the carrier gas passage 78 toward a downward side thereof The carrier gas is supplied at a high pressure, for example, of 2.5 kg/cm² or so. Here, although argon gas is used as the carrier gas, the present disclosure is not limited thereto, and other rare gas, such as He, may also be used.

The reaction gas supply system 64 has a reaction gas passage 102 connected to one of the remaining two gas dispersion nozzles, for example, the gas dispersion nozzle 32. A flow rate controller 104 such as a mass flow controller and an opening/closing valve 106 are installed in sequence in the middle of the reaction gas passage 102, and as necessary, the reaction gas can be supplied while its flow rate is controlled.

Here, the reaction gas includes an oxidation gas, for example ozone (O₃), and allows a zirconium oxide film to be formed by oxidizing a raw material containing Zr. In addition, the purge gas supply system 65 has a purge gas passage 108 connected to the remaining one gas dispersion nozzle, i.e., the gas dispersion nozzle 33. A flow rate controller 110 such as a mass flow controller and an opening/closing valve 112 are installed in sequence in the middle of the purge gas passage 108, and as necessary, the purge gas can be supplied while its flow rate is controlled. The purge gas includes an inert gas, such as N₂ gas.

The general operation of the heat treatment apparatus 2 configured as above is controlled by an apparatus control unit 116 such as a computer, and a computer program for performing the operation is stored in a memory medium 118. The memory medium 118 includes, for example, a flexible disk, a CD (Compact Disc), a hard disk, a flash memory, a DVD, or the like. Specifically, the start or stop of the supply, the control of flow rate of each gas, the control of process temperature or pressure, and the like are performed by commands from the apparatus control unit 116.

Hereinafter, a method of forming a film using the heat treatment apparatus 2 configured as above will be described. Here, a case where a zirconium oxide thin film is formed using tris(dimethylamino)cyclopentadienyl zirconium[C₁₁H₂₃N₃Zr] as the raw material and ozone, which is an oxidation gas, as the reaction gas will be described as an example.

Specifically, the thin film is formed by repeating one cycle more than once, which consists of a supply step of alternately supplying the source gas and the reaction gas (ozone) in a pulse shape for a certain supply period and a stop step of stopping the supply.

When the source gas is supplied, in the source gas supply system 62, the raw material 66 is vaporized and saturated in the raw material storage tank 68 by being heated, and the carrier gas having its flow rate controlled is supplied into the raw material storage tank 68 through the gas supply portion 74, whereby the saturated source gas carried by the carrier gas flows out of the gas outflow portion 76 toward the source gas passage 70. Then, the source gas carried together with the carrier gas is injected from the gas dispersion nozzle 30 installed in the processing container 8 to be supplied into the processing container 8.

In addition, when the reaction gas is supplied, in the reaction gas supply system 64, the reaction gas having its flow rate controlled is allowed to flow into the reaction gas passage 102, and the reaction gas is injected from the gas injection hole 32A of the gas dispersion nozzle 32 to be supplied into the processing container 8. Further, when the purge gas is supplied, in the purge gas supply system 65, the purge gas having its flow rate controlled is allowed to flow into a purge gas passage 108, and the purge gas is injected from the gas injection hole 33A of the gas dispersion nozzle 33 to be supplied into the processing container 8.

The gas supplied into the processing container 8 flows between the respective wafers W in the transverse direction (horizontal direction) while being brought into contact with the respective wafers and is introduced into the gap between the inner container 4 and the outer container 6 through the exhaust opening 36. The gas also flows down within the gap and then is discharged out of the container by the evacuation system 46 rather than the gas outlet 44.

In a practice sequence, first, the wafer boat 12 having, for example, 50 to 150 sheets of 300 mm wafers W mounted thereto at room temperature is loaded into the processing container 8 having a predetermined temperature in advance by being lifted up from the bottom thereof. Then, the container is sealed by closing the lower end opening portion of the manifold 10 in the lid portion 18.

Then, the processing container 8 is evacuated to maintain a pressure therein of 0.1 to 3 torr, and at the same time, the power supplied to the heater 54 is increased to increase the wafer temperature and maintain the process temperature, for example at 250 degrees C. or so. Then, the source gas supply system 62 and the reaction gas supply system 64 of the gas supply apparatus 60 are driven, so that as described above, the source gas and ozone are alternately supplied into the processing container 8 and thin films of zirconium oxide are laminated on surfaces of the wafers W. Specifically, in the raw material storage tank 68 of the source gas supply system 62, the raw material 66 is heated by the raw material heater 69, so that the source gas is generated in the raw material storage tank 68 and saturated therein.

If the film formation treatment (heat treatment) is started, a source gas supply step is performed, in which the carrier gas consisting of Ar is first allowed to flow into the raw material storage tank 68, and the source gas in the raw material storage tank 68 is allowed to flow together with the carrier gas into the processing container 8. Accordingly, the source gas is attached to the surfaces of the wafers W.

Here, the carrier gas has a flow rate in a range from 2 to 15 slm, for example 7 slm, and the gas is allowed to flow, for example, for a time in a range from 1 to 10 seconds, which is just a short time, for example 5 seconds or so in this embodiment.

Next, in a state where the supply of the carrier gas and source gas is stopped, a purge step of removing the residual gas within the processing container 8 is performed. In this purge step, the residual gas in the processing container 8 may be removed by stopping the supply of all of the gases, the purge gas consisting of an inert gas, such as N₂ gas, may be supplied into the processing container 8 to substitute for the residual gas, or the combination thereof may be possible. Here, N₂ gas has a flow rate in a range from 0.5 to 15 slm, for example 10 slm in this embodiment. Such a purge step is performed for a time in a range from 4 to 120 seconds, for example 60 seconds in this embodiment.

If the purge step as described above is terminated, a reaction gas supply step is then performed. Here, the reaction gas supply system 64 is used to supply the reaction gas consisting of ozone into the processing container 8. Accordingly, the source gas attached to the surfaces of the wafers W reacts with the ozone to form a thin film of a zirconium oxide. A process time for the reaction gas supply step of forming the film is in a range from 50 to 200 seconds, for example 100 seconds or so in this embodiment.

If the reaction gas supply step is terminated, a purge step of removing the residual gas in the processing container 8 is performed. Accordingly, the aforementioned respective steps are performed repeatedly predetermined times, whereby a thin film of zirconium oxide is laminated.

When the film formation treatment as described above is performed, in the source gas supply system 62, since a large amount of the source gas needs to be introduced into the processing container 8, it is necessary to allow a large amount of the carrier gas to flow and supply the carrier gas into the raw material storage tank 68. In such a case, in a conventional source gas supply system (gas supply apparatus), since a carrier gas supplied into the raw material storage tank 68 at a high pressure, for example, of 2.5 kg/cm² or so strongly collides with the liquid surface of the raw material 66, fluctuation of the liquid surface or incorporation of bubbles thereinto is generated, which causes apprehension that particles are generated.

However, in case of the gas supply apparatus 60, the gas supply portion 74 of the source gas supply system 62 is fitted with the baffle plate 80, so that the carrier gas injected from the gas supply opening 84 can be prevented from being brought into direct contact with the liquid surface of the raw material 66, thereby resultantly preventing the fluctuation of the liquid surface or the incorporation of bubbles thereinto from being generated.

Specifically, the carrier gas strongly injected from the gas supply opening 84 of the lower end of the gas nozzle 82 installed to the gas supply portion 74 toward immediately therebelow strongly collides with the baffle plate 80 positioned therebelow, so that the force of the gas becomes weakened. The weakened carrier gas becomes more weakened by the mesh member 86 having a fine net installed to enclose a space between the baffle plate 80 and the gas supply opening 84, and the proceeding direction of the carrier gas is changed into an inclined downward direction or the horizontal direction, and at the same time, the carrier gas passes through the mesh member 86 to thereby be supplied to the upper space portion 68A in the raw material storage tank 68. Therefore, the strong carrier gas can be prevented from being brought into direct contact with the liquid surface of the raw material 66. As a result, the fluctuation (shake) of the liquid surface or the incorporation of bubbles thereinto is prevented, and thus, particles can be prevented from being generated.

As described above, in the gas supply apparatus having the source gas supply system 62 for supplying the source gas, which is generated from the liquid raw material 66 consisting of an organic metal material, using the carrier gas, to the processing container 8 for performing heat treatment on the object W to be treated, the baffle plate 80 for preventing the carrier gas injected from the gas supply portion 74 from being brought into direct contact with the liquid surface of the raw material 66 is installed to the gas supply portion 74 of the raw material storage tank 68 having the liquid raw material 66 stored therein, so that the carrier gas is prevented from strongly colliding with the liquid surface. Thus, it is possible to prevent the liquid surface of the raw material 66 from being severely shaken or bubbles from being incorporated into the liquid surface. Accordingly, the generation of particles can be suppressed, thereby preventing the particles from being attached to the surfaces of the object to be treated.

### <Evaluation of Baffle Plate>

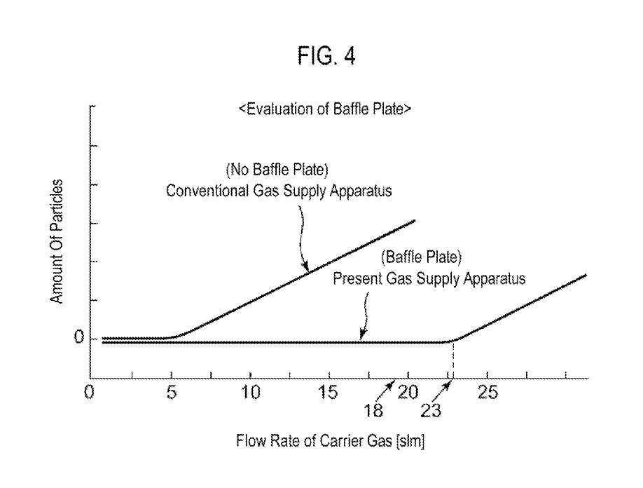

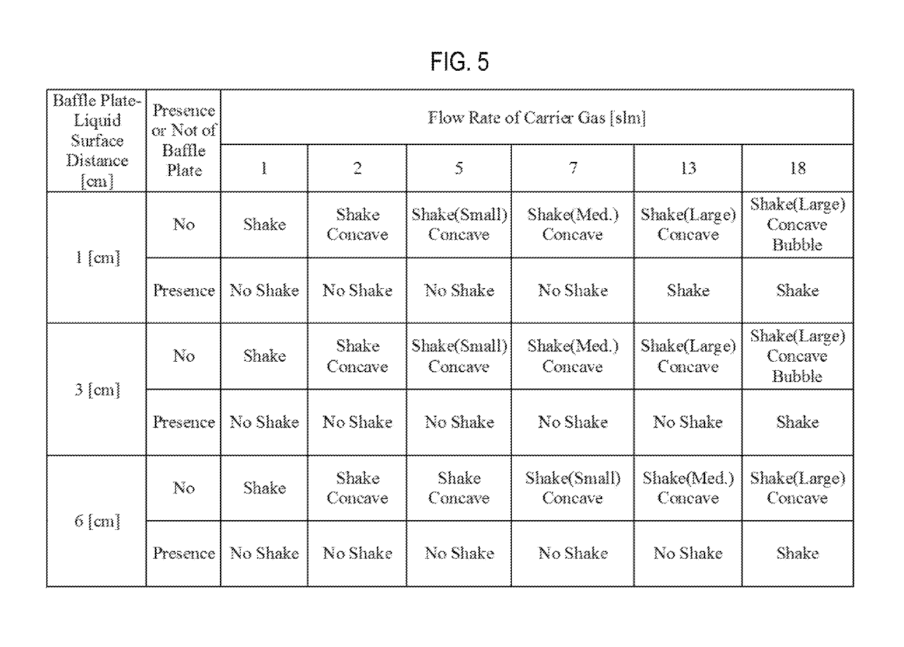

Here, tests for evaluating the aforementioned gas supply apparatus 60 were performed, and the evaluation results thereof will be described with reference to FIGS. 4 and 5. FIG. 4 is a graph showing evaluation results of the gas supply apparatus 60, wherein the horizontal axis represents a flow rate of a carrier gas, and the vertical axis represents the amount of particles attached onto the wafer. Here, the gas supply opening 84 of the gas nozzle 82 was set to have a diameter D of 3.2 mm, the baffle plate 80 was set to have a diameter L of 2.0 mm, and a distance between the gas supply opening 84 and the baffle plate 80 was set to be 32 mm. In addition, the mesh member 86 had a mesh size of 0.4 μm.

As shown by FIG. 4, in case of the conventional gas supply apparatus without the baffle plate, when the flow rate of the carrier gas was increased, almost no particle was generated in the beginning, but if the flow rate of the carrier gas was increased over 5 slm, the amount of particles was gradually increased. On the other hand, in the gas supply apparatus having the baffle plate according to the present disclosure, even though the flow rate of the carrier gas was increased, particles were hardly generated. Almost no particle was generated until the flow rate of the carrier gas exceeded 18 slm and then reached 23 slm, and the amount of particles was gradually getting increased as the flow rate of the carrier gas was increased over 23 slm. In addition, when the flow rate of the carrier gas was 18 slm or less, the liquid surface was almost not shaken like the state of the liquid surface when there was no baffle plate and the flow rate of the carrier gas was 2 slm or so. In this manner, it is possible to understand that particles can be prevented from being generated by installing the baffle plate 80 to the gas supply portion 74.

FIG. 5 is a diagram showing a relationship between the flow rate of the carrier gas, a distance between the baffle plate and the liquid surface of the raw material, and a state of the liquid surface thereof. Here, while the flow rate of the carrier gas was increased, a state of the liquid surface of the raw material was observed with the naked eye. A distance between the baffle plate and the liquid surface was varied from 1 to 6 cm. In addition, the flow rate of the carrier gas was changed in a range from 1 to 18 slm. The dimensions and the like of the gas supply portion 74 and the baffle plate 80 are the same as those described in FIG. 4. In addition, “no” baffle plate represents the conventional gas supply apparatus.

As shown by FIG. 5, in the conventional gas supply apparatus having “no” baffle plate, when a baffle plate-liquid surface distance is in a full range from 1 to 6 cm and the flow rate of the carrier gas is 1 slm, the liquid surface is in a “shake” state. As the flow rate of the carrier gas increases from such a state, the shake state of the liquid surface varies from “small” to “medium” and “large” in order. In addition, at the same time, a “concave” state is generated on the liquid surface by depression due to the force of the carrier gas. The aforementioned tendency becomes severe as the distance between the baffle plate and the liquid surface gets shortened. In particular, when the distance between the baffle plate and the liquid surface is 1 cm and 3 cm and the flow rate of the carrier gas is 18 slm, it can be understood that the liquid surface exhibits a “bubble” state, from which a large amount of particles are expected to be generated, which is in an undesirable state.

On the other hand, in the gas supply apparatus with “presence” of the baffle plate according to the present disclosure, the liquid surface is observed as the “shake” state only when the distance between the baffle plate and the liquid surface distance is 3 cm and 6 cm and also the flow rate of the carrier gas is 18 slm, and the distance between the baffle plate and the liquid surface distance is 1 cm and also the flow rate of the carrier gas is 13 slm and 18 slm. In the other conditions, the liquid surface is in a “no shake” state. Thus, it can be understood that an effect of suppressing the generation of particles can be sufficiently exhibited.

### <Modification>

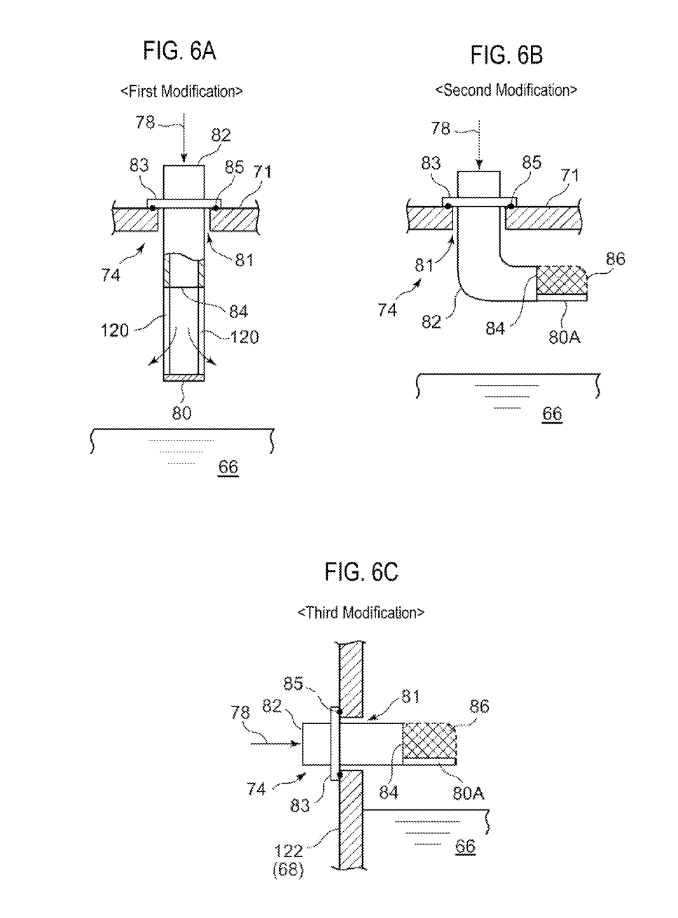

Next, modifications of the gas supply apparatus will be described with reference to FIGS. 6A to 6C. FIGS. 6A to 6C show partially enlarged views of modifications of the gas supply portion in the source gas supply system of the gas supply apparatus according to some embodiments, wherein FIG. 6A shows a first modification, FIG. 6B shows a second modification, and FIG. 6C shows a third modification. In addition, the same reference numerals designate the same elements as those shown in FIGS. 1 to 3, and redundant descriptions thereof will be omitted.

### [First Modification]

Although in the previous embodiment, the mesh member 86 is used to support the baffle plate 80, the present disclosure is not limited thereto, and the baffle plate 80 may be supported by support arms. In such a first modification, as shown in FIG. 6A, the mesh member 86 (see FIG. 3) is not installed, but support arms 120 are installed instead. That is, the gas supply opening 84 of the leading end of the gas nozzle 82 of the gas supply portion 74 and the baffle plate 80 are connected through one or a plurality of narrow support arms 120, which in turn support the baffle plate 80. In the illustrated example, the baffle plate 80 is supported by the two support arms 120.

The support arms 120 can be made of a corrosion resistance material such as stainless steel.

In the first modification, since the mesh member 86 is not installed, the suppression effect of the force of the carrier gas by means of the mesh member 86 disappears, but the same functional effect as the previous embodiment can be exhibited in the first modification nevertheless. In addition, it is natural that the modified forms of the previous embodiment described with reference to the previous FIGS. 1 to 3 may be applied to this modification.

### [Second Modification]

In addition, although the gas nozzle 82 in the shape of a straight line is installed in the previous embodiment, in a second modification as shown in FIG. 6B, an L-shaped gas nozzle 82, which is bent into an “L” shape at a predetermined angle, for example a right angle, may be used instead. In such a case, the gas injection direction of the carrier gas from the gas nozzle 82 is set to be in the horizontal direction, i.e., to be parallel with the liquid surface of the raw material 66.

In this case, in order that the carrier gas injected from the gas supply opening 84 of the gas nozzle 82 in the horizontal direction is prevented from being diffused slantingly downward and being brought into direct contact with the liquid surface of the raw material 66, a baffle plate 80A is installed to extend forwardly from the gas supply opening 84 along a bottom side of the gas injection direction to be parallel with the liquid surface of the raw material 66.

In such a case, the baffle plate 80A is formed in the shape of a quadrangle, for example a rectangle. Although an upper space of the baffle plate 80A may be open, in this embodiment, the mesh member 86 is installed to enclose the front of the gas supply opening 84 and the upper space of the baffle plate 80A. The same functional effect as the previous embodiments can be exhibited in this second modification.

### [Third Modification]

Although the gas nozzle 82 bent in an “L” shape is used in the second modification, in a third modification as shown in FIG. 6C, the gas nozzle 82 is formed in the shape of a straight line instead. The gas nozzle 82, which is configured like the second modification in terms of the mesh member 86 or the baffle plate 80A in the vicinity of the gas supply opening 84 of the leading end of the gas nozzle 82, may be detachably mounted to a sidewall 122 of the raw material storage tank 68. The same functional effect as the previous embodiments can be exhibited in this third modification.

Further, although the gas nozzle 82 is installed to the gas supply portion 74 in the respective embodiments, the present disclosure is not limited thereto, and a hole is directly formed in the ceiling 71 of the raw material storage tank 68 without using the gas nozzle 82 itself and the hole may be used as the gas supply opening 84. Furthermore, although it has been described as an example in the aforementioned embodiments that the gas supply apparatus 60 is applied to the so-called batch type heat treatment apparatus 2 capable of processing a plurality of semiconductor wafers W at a time, the present disclosure is not limited thereto and may be naturally applied to a single type heat treatment apparatus for processing semiconductor wafers one by one.

In addition, although the embodiments have been described using a semiconductor wafer as the object to be treated, the semiconductor wafer includes a compound semiconductor substrate of GaAs, SiC, GaN or the like or a silicon substrate. Furthermore, the present disclosure is not limited to these substrates and may be applied to a glass substrate used in a liquid crystal display, a ceramic substrate, or the like.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A gas supply apparatus having a source gas supply system configured to supply a source gas to a processing container using a carrier gas, wherein the source gas is generated from a liquid raw material consisting of an organic metal material, and wherein the processing container performs heat treatment on an object to be treated, the gas supply apparatus comprising:
a raw material storage tank configured to store the liquid raw material therein;
a gas supply portion installed to the raw material storage tank and connected to a carrier gas passage, wherein the carrier gas passage allows the carrier gas to flow;
a gas outflow portion installed to the raw material storage tank and connected to a source gas passage, wherein the source gas passage allows the source gas to flow; and
a baffle plate configured to prevent the carrier gas injected from the gas supply portion from being brought into direct contact with a liquid surface of the raw material.

2. The gas supply apparatus of claim 1, wherein the gas supply portion has a gas nozzle inserted into the raw material storage tank.

3. The gas supply apparatus of claim 1, wherein the baffle plate is installed in a gas injection direction from the gas supply portion.

4. The gas supply apparatus of claim 1, wherein the baffle plate is supported by a mesh member having a ventilation property, wherein the mesh member is installed by connecting the baffle plate and a gas supply opening of the gas supply portion to enclose a space therebetween.

5. The gas supply apparatus of claim 1, wherein the baffle plate is supported by a support arm.

6. The gas supply apparatus of claim 1, wherein a diameter of the baffle plate is set within a range from more than or equal to ½ times to less than or equal to 2 times in comparison to a diameter of the gas supply opening.

7. The gas supply apparatus of claim 1, wherein the baffle plate is installed to be parallel with a liquid surface of the raw material.

8. The gas supply apparatus of claim 1, wherein the gas nozzle is installed so that a gas injection direction is parallel with a liquid surface of the raw material.

9. The gas supply apparatus of claim 8, wherein the baffle plate is installed to extend forwardly from a gas supply opening of the gas supply portion along a bottom side of the gas injection direction to be parallel with the liquid surface of the raw material.

10. A heat treatment apparatus configured to perform heat treatment on an object to be treated, comprising:
a processing container configured to accommodate the object to be treated therein;
a holding unit configured to hold and support the object to be treated in the processing container;
a heater configured to heat the object to be treated;
an evacuation system configured to evacuate an atmosphere of processing container therein; and
the gas supply apparatus of claim 1.
